(19) United States
(12) Patent Application Publication
(10) Pub. No.: US 2026/0361127 A1
(43) Pub. Date: Nov. 12, 2026

(54) ADDRESS ASSIGNMENT FOR A MODULAR POWER DISTRIBUTION UNIT

(71) Applicants: LEGRAND SNC, LIMOGES (FR); LEGRAND FRANCE, LIMOGES (FR)

(72) Inventor: Franck DELPINO, SEYSSINET-PARISET (FR)

(21) Appl. No.: 18/707,844

(22) PCT Filed: Jan. 10, 2023
(86) PCT No.: PCT/FR2023/050027

§ 371 Date: Jul. 30, 2026

(30) Foreign Application Priority Data
Jan. 31, 2022 (FR) 2200798

(51) Int. Cl. H02J 13/38; G06F 1/18

(52) U.S. Cl. CPC H02J 13/38; G06F 1/189

(57) ABSTRACT

The invention relates to a secondary module for a PDU, comprising: —a set of electrical sockets connected to an internal connection socket for the supply of electrical power; —at least one interface for transmitting data with another module in the PDU; —management means for individually managing the electrical sockets by means of messages exchanged with a base module of the PDU that identify a given electrical socket by a unique address; —wherein, in response to an invitation signal received from a first interface, the management means are adapted to transmit an address request message over the first interface specifying the number of electrical sockets, and to store the one or more addresses in response to a plurality of address assignment messages.

### FIELD OF THE INVENTION

The present invention relates to power distribution units (or PDUs). It relates more particularly to modular PDUs and to the modules constituting these modular PDUs.

It applies in particular to smart power distribution units, PDUs.

### BACKGROUND OF THE INVENTION

A power distribution unit (PDU) is a device equipped with a plurality of outputs enabling electricity distribution to a plurality of equipment from a single main power supply. Schematically, therefore, such equipment comprises an input electrical supply socket and a set of electrical sockets on which various pieces of equipment can be connected to be powered.

These power distribution units have numerous applications, both in the industrial field and in that of personal use, in home automation, in particular.

More recently, smart distribution units have been marketed in order to meet the remote management needs of units and, in particular, of each of the sockets that compose it.

This management leads to communication between an external device and the power distribution unit. In order to be able to manage individually each outlet of this unit, the external device must be able to identify them by means of an identifier or an address. In parallel, a need for modular power distribution units has appeared to be able to quickly and easily produce units corresponding to specific needs. Depending on the desired specifications, in particular in terms of number of electrical sockets, it is then possible to aggregate modules with appropriate types and numbers.

One difficulty then appears to reconcile the design flexibility of modular power distribution units with the need to be able to remotely manage each of the sockets, or other elements. Indeed, it is then necessary to assign addresses to each socket, given that, this number is not predetermined for a given power distribution unit.

### SUMMARY OF THE INVENTION

An objective of the present invention is to provide a solution making it possible to obtain a power distribution unit that is both smart and modular. In particular, one objective is that this solution is simple to use and deploy.

Additionally, the invention allows the number of sockets of a power distribution unit to change without requiring complex reconfiguration operations to assign or eliminate socket addresses.

To this end, according to a first aspect, the present invention can be implemented by a secondary module for a power distribution unit, comprising
a set of electrical sockets, connected to an internal connection socket enabling an energy supply by an input module of said power distribution unit,
at least one interface for transmitting data with another module in said power distribution unit,
management means for individually managing the electrical sockets of said set, by means of messages exchanged, via said at least one interface, with a base module of said power distribution unit, identifiers of an electrical socket of said set that is determined by a unique address,
wherein said management means are adapted to, in response to an invitation signal received from a first interface among said at least one interface, transmit, on said first interface, an address request message specifying the number of electrical sockets of said set, and, to store said one or more addresses, in response to one or more address assignment messages.

According to preferred embodiments, the secondary module according to the invention comprises one or more of the following features which may be used separately or in partial combination with each other or in total combination with each other:
said management means are adapted to, after having received said one or more assignment messages, transmit a second invitation signal on a second interface among said at least one interface, said second interface being distinct from said first interface;
the management means are composed of a printed circuit comprising a programmable microcontroller, a memory and circuits enabling the connection between said microcontroller, said memory and said at least one interface;
said at least one interface comprises a unidirectional wire connector for the transmission of said invitation signal, and a connector for a set of bidirectional wires for the transmission of said messages;
said invitation signal corresponds to a predetermined level of voltage over said unidirectional wire;
said unique addresses are assigned by a counter of said base module, said address assignment messages contain a value of said counter, and said secondary module determines the unique addresses assigned to the sockets of said set depending on said value and said number of sockets, in a predetermined order.

According to another aspect, the present invention can also be implemented by a base module for a power distribution unit, comprising
at least one interface for transmitting data with a secondary module in said power distribution unit,
management means adapted to issue an invitation signal on a first interface among said at least one interface, then to, in response to an address request message received on said first interface, assign one or more unique addresses and to transmit same over said first interface, in the form of one or more address assignment messages.

According to preferred embodiments, this base module comprises one or more of the following features which may be used separately or in partial combination with each other or in total combination with each other:
said management means are adapted to emit a new invitation signal on a second interface from said at least one interface, when a predetermined duration has elapsed after the reception of a last message via said first interface;
the base module comprises a management interface enabling exchanges of management messages with external devices, comprising at least one socket address;
the management means are composed of a printed circuit comprising a programmable microcontroller, a memory and circuits enabling the connection between said microcontroller, said memory and said at least one interface;
said at least one interface comprises a unidirectional wire connector for the transmission of said invitation signal, and a connector for a set of bidirectional wires for the transmission of said messages;
said invitation signal corresponds to a predetermined level of voltage over said unidirectional wire;
said unique addresses are assigned by a counter of said base module, said address assignment messages contain a value of said counter, and said secondary module determines the unique addresses assigned to the sockets of said set depending on said value and said number of sockets, in a predetermined order.

According to another aspect, the present invention can also be implemented by a power distribution unit comprising a base module and at least one secondary module as defined above, said modules being connected via their at least one respective interface, so as to form a chain.

According to preferred embodiments, this power distribution unit comprises one or more of the following features which may be used separately or in partial combination with each other or in total combination with each other:
said unique addresses are assigned by a counter of said base module, said address assignment messages contain a value of said counter, and said secondary module determines the unique addresses assigned to the sockets of said set depending on said value and said number of sockets, in a predetermined order;
the power distribution unit further comprises an input module comprising an electrical supply socket;
said at least one interface further comprises two pairs of connectors for the power supply of said management means, the two pairs being arranged so that said interface is reversible, and the supply being provided by a current converter arranged in said base module.

According to another aspect, the present invention can also be implemented by a method for assigning addresses to electrical sockets of a power distribution unit, comprising a base module comprising at least one interface through which at least one secondary module is accessible comprising a set of electrical sockets connected to an internal connection socket enabling an energy supply by an input module of said power distribution unit, wherein, for each of said at least one interface, said base module transmits an invitation signal,

then, iteratively:
said at least one secondary module transmits, upon receipt of said invitation signal, an address request message to said base module, indicating the number of electrical sockets of said assembly;
said base module assigns a unique address for each socket, and transmits such address(es) as one or more address assignment messages;
said at least one secondary module stores the unique address(es), then transmits a second invitation signal to another secondary module among said at least one secondary module, if there is one.

The invention can also be implemented by a data processing center comprising at least one power distribution unit as defined above.

According to preferred embodiments, this data processing center further comprises an external management device adapted to exchange with said power distribution unit by means of management messages comprising at least one socket address.

Further features and advantages of the invention will become apparent from the following description of a preferred embodiment of the invention, given by way of example and with reference to the attached drawings

### BRIEF DESCRIPTION OF THE FIGURES

The attached drawings show the invention:

FIG. 1 schematically shows a power distribution unit according to one embodiment of the invention.

FIG. 2 schematically shows an example of a secondary module and a base module, within a power distribution unit, according to one embodiment of the invention.

FIG. 3 shows an example bus making it possible to connect two interfaces of secondary and/or base modules, according to one embodiment of the invention.

FIG. 4 shows an example interface and connector, according to one embodiment of the invention.

FIG. 5 schematically shows the exchanges of data between a base module and a plurality of secondary modules, within a power distribution unit, according to one embodiment of the invention.

### DETAILED DESCRIPTION OF EMBODIMENTS OF THE INVENTION

A power distribution unit may comprise different modules, one or more of these modules comprising one or more electrical sockets. It is thus possible to construct, on demand, a power distribution unit comprising a desired total number of sockets by incorporating the correct number of modules within the power distribution unit.

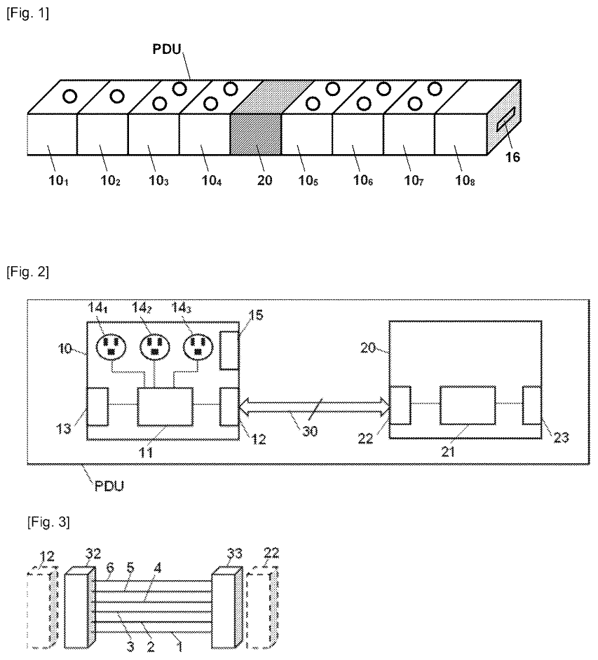

FIG. 1 schematically shows a power distribution unit PDU according to one embodiment of the invention. This is composed of a basic (or master) module 20 and of a plurality of secondary (or “slave”) modules 10₁, 10₂, 10₃ . . . 10₈. The number of secondary modules is arbitrary and may, in an extreme case, be reduced to one.

The power distribution unit also comprises an electrical supply socket 16. According to one embodiment, this electrical supply socket 16 belongs to a particular secondary module 10₈ called an “input module”.

Some or all of the secondary modules have output electrical sockets. The power distribution unit PDU also comprises means for distributing the electrical current from the supply socket 16 of the input module to each of the electrical sockets of the secondary modules.

Thus, from a supply socket, power (or electricity, both words may be used interchangeably below) can be conveyed to various equipment that can connect to the various sockets of the modules of the power distribution unit.

Such a power distribution unit can find an application, for example, in data centers, or data processing centers. A power distribution unit can make it possible to power each of the servers, or other network equipment, of a rack, for example.

Of course, other applications are possible. In an industrial or professional environment, such a device can be used to power a large number of co-located equipment. However, a similar need may also appear within personal residence, in particular due to the strong growth of digital equipment and home automation.

As shown in FIG. 1, the secondary modules may be of different types.

The type of secondary module can in particular be characterized by a number of electrical sockets (at the socket), illustrated in the figure by simple circles. It is thus possible to provide secondary modules with 2, 3, 5, 8 . . . electrical sockets. In the example shown, the input module 10N does not have an output electrical socket.

Also, the type of secondary module can be characterized by the type of sockets that it comprises. For example, it may have C13 sockets, C19 sockets . . . .

A C13 socket is suitable for office computers, simple industrial equipment, as well as relatively low-power equipment of computer data centers (such as switches or small servers). It supports currents up to 10 to 15 amps, for voltages between 90 and 250 V.

A C19 socket is suitable for large-power equipment of computer data centers, such as computer server chassis (for example the Poweredge M 1000 e box from Dell11 or C7000 boxes from HP) as replacement for a C13 socket when the requested power is too great for this type of socket. It supports currents up to 15 to 20 amps, for voltages between 100 and 240 V.

Other types of sockets are of course possible, in particular depending on uses and countries, without loss of generality.

According to one embodiment, some secondary modules may be of a type suitable for performing functions other than power distribution. For example, a type of secondary module can embed environmental sensors (temperature, humidity rate, etc.).

Typically, the power distribution unit PDU forms a unidirectional chain of modules, that is outside the two end modules, each module has exactly two neighbors.

According to one embodiment of the invention, the base module 20 is located substantially in the middle of the power distribution unit and, in general, has a secondary module on each side.

It is possible to call each of the two subsets of modules located on either side of the base module a “branch”. In FIG. 1, there is therefore a “left” branch composed of secondary modules 10₁, 10₂, 10₃, 10₄, and a “right” branch composed of the secondary modules 10₅, 10₆, 10₇, 10₈.

According to the invention, the power distribution unit is “smart”, in other words it offers communication interfaces to allow it to be managed remotely.

Depending on the embodiments of the invention, the management comprises either or both of two aspects:
Monitoring, or surveillance, which comprises the collection of measurements or other parameters associated with each socket;
Command, or control, which comprises the remote activation of certain parameters associated with each socket in order to modify the behavior thereof.

Thus, data messages can be exchanged between an external management device and the different modules of the power distribution unit. Some messages aim to transmit data coming from the modules (measurements, etc.) to this external device, while other messages are aimed at transmitting data (commands, requests, etc.) to the secondary modules.

According to one embodiment, the base module acts as an interface between the exterior management device and the various secondary modules.

To allow the external device to operate, an address, or identifier, must be assigned to each manageable object of the power distribution unit. These manageable objects comprise the electrical sockets 10₁, 10₂, etc. 10₈, insofar as it is desired to be able to supervise and control the behavior of each socket individually.

By virtue of such an address, the external device can identify the socket from which a data message has arrived, and, conversely, can transmit a data message to act on a given socket.

According to the invention, the role of the base module is to dynamically assign addresses to the managed objects (in particular to the electrical sockets) of the secondary modules composing the power distribution unit.

According to various aspects, the invention relates to a base module and a secondary module adapted to collaborate within a power distribution unit, as well as this power distribution unit comprising a set of such modules.

FIG. 2 schematically shows an example of a secondary module 10 and a base module (or main, or “master” module) 20 within a power distribution unit PDU, according to one embodiment of the invention.

Only one secondary module 10 is shown in FIG. 2 for the clarity of the figure, but, in practice, the power distribution unit PDU may comprise a plurality of such secondary modules.

According to embodiments, the modules may comprise a housing making it possible to house the various elements that make it up. This housing may be a rigid structure, typically made of plastic and/or metal material, and comprise orifices in order to allow connection with the sockets and interfaces.

The secondary module 10 comprises a set of electrical sockets 14₁, 14₂, 14₃. The number of these sockets can be variable according to the secondary modules as described above. In some cases, the set of electrical sockets can be reduced to a single socket. Likewise, the sockets may be of different types.

The electrical sockets are connected to an internal connection socket 15 allowing a power supply by an input module contained in the power distribution unit. Thus, the energy introduced by the electrical supply socket 16 of the input module can be distributed both among all of the secondary modules, then, within each of these secondary modules, among the set of “output” electrical sockets, 14₁, 14₂, 14₃.

Each electrical socket can be supplied through a relay. This relay can be monitored, or controlled, by management means 11, in order to allow the energy coming from the internal connection to pass to the associated electrical socket, or prevent it from passing through.

Furthermore, the secondary module 10 comprises at least one interface, 12, 13, for transmitting data with another module (possibly through a neighboring module), and management means 11 for individually managing the electrical sockets, by means of messages exchanged, via these interfaces, with the base module 20 of the power distribution unit PDU. These messages identify an electrical socket determined by a unique address.

As will be seen later, the modules being connected to form a chain, the interfaces make it possible to transmit data with remote modules via neighboring modules. According to one embodiment, the management means 11 are composed of a printed circuit comprising at least one programmable microcontroller, a memory and circuits enabling the connection between the microcontroller, the memory and the interface(s) 12, 13.

Advantageously, the same software program can be implemented on all the secondary modules and be adapted to discover its environment (number of sockets on the module, any other manageable objects, etc.). Such an embodiment facilitates the deployment of the invention, in particular by maintaining a single version of the software program.

The management means 11 are therefore connected with the interfaces 12, 13, in order to allow the transmission of the messages, or more generally of data, between the management means and these interfaces and allow them to thus communicate with the neighboring modules and, through them, with the remote modules.

In FIG. 2, the interface 12 is connected to an interface 22 of the base module 20. The management means 11 can therefore transmit data with management means 21 of the base module 20.

The secondary module 10 may also comprise a second interface 13, making it possible to transmit data with a module, different from the module connected to the first interface 12. According to a typical embodiment, each module comprises exactly two interfaces 12, 13, enabling it to connect directly to two distinct neighboring modules. The modules are arranged longitudinally within the power distribution unit PDU, so that besides the two modules located at the ends, each module is connected, interface to interface, to two neighboring modules, thus forming a chain.

The messages exchanged between a given secondary module and the base module can be conveyed, hence, from neighboring modules to neighboring modules. Thus, using the example of FIG. 1, a message transmitted between the secondary module 10₁ and the base module 20 is conveyed through the secondary modules 10₂, 10₃, 10₄. Thus, the messages received on a first interface of a secondary module can be either processed by the management means 11 of that module (if they relate to an electrical socket, or another manageable object, of that module), or retransmitted on the other interface of that same secondary module.

The connections between the successive module interfaces of a chain thus form a data bus, wherein, at each transmission (or “hop”), the modules determine whether a message relates to a manageable object that they contain. In this way, the set of secondary modules is accessible, for the base module, directly (for the neighbors) or indirectly (for the remote modules, via a chain of secondary modules).

The base module can also have two interfaces, 22, 23, so as to be able to transmit data with secondary modules located on either side. As mentioned above, the base module can preferentially be located substantially in the middle of the power distribution unit PDU. Each interface of the base module 20 forms an end of a data bus associated with a “branch” of secondary modules. In other words, each interface of the base module makes it possible to access a set of secondary modules corresponding to the associated branch.

Like the secondary modules, the base module 20 comprises management means 21. According to one embodiment, the management means 21 are composed of a printed circuit comprising at least one programmable microcontroller, a memory and circuits enabling the connection between the microcontroller, the memory and the interface(s) 22, 23.

The software program implemented by these management means comprises functionalities different from those of the software program implemented on the management means 11 of the secondary modules. However, the same software program can be implemented, adapted to adapt its mode of operation to the type of module on which it is implemented.

The operations of the management modules 11, 21 of the secondary modules 10, respectively base modules, 20, will be explained later, in particular for the assignment of addresses to the electrical sockets of the secondary modules.

The connection between two interfaces of neighboring modules can be done by a ribbon of wires 30.

An embodiment of this ribbon is illustrated in FIG. 3.

The ribbon consists of two connectors 32, 33, adapted to connect physically and electrically with two interfaces, respectively 12, 22, of modules neighboring each other.

This ribbon is adapted to transmit invitation signals and messages between the modules of a power distribution unit PDU.

According to one embodiment of the invention, the ribbon 30 is also suitable for supplying energy to the module management means. A particular module can provide an energy source, and thus distribute it to the different module management means of the PDU. Typically, the base module has a current converter adapted to transform the current received from the supply of the input module into a low-voltage current, for example 12V making it possible to supply the management means of the various modules through the ribbons 30.

According to one embodiment, the ribbon 30 has a wire enabling the transmission of an invitation signal. This wire may be unidirectional.

According to one embodiment, the voltage levels on this wire make it possible to convey an invitation information. For example, setting the voltage to a predetermined level (e.g., a low level at 0 Volts) forms such an invitation signal. The voltage can be maintained at this low level for a predetermined duration.

The ribbon may also comprise a set of wires to transmit messages.

According to one embodiment, a single wire is provided for the transmission of messages. In particular, provision may be made for the transmission of messages to be carried out in serial mode on this bidirectional wire alone.

This transmission can follow a protocol of the UART type. The term UART stands for “Universal Asynchronous Receiver/Transmitter”, and defines a protocol, or a set of rules, dedicated to the exchange of serial data between two devices. A UART component can therefore be provided to perform the series/parallel conversion between the microcontrollers of the management means and the interfaces.

A protocol can be provided in particular to allow a transmission of messages in a bidirectional manner and to adjust its access. In particular, the base module always initiates the communication, so that the secondary module can use the bidirectional wire only in response to a request message. Thus, there can be no access collision. The interfaces of the secondary and base modules are adapted to collaborate with such a ribbon 30. In particular, according to one embodiment, an interface comprises a first connector for a unidirectional wire for the transmission of the invitation signal, and a second connector for a set of bidirectional wires for the transmission of messages. According to one embodiment, the set of bidirectional wires only contains one, and the second connector is adapted for this single wire (wire 4 in FIG. 3). These first and second connectors may be the same physical component.

According to one embodiment, the interfaces are intended to be reversible relative to the connectors of the ribbon, that is to say that the ribbon can be connected in the various physically possible positions without causing damage. In particular, the power supply wires are adapted to, regardless of the connection position, not generate a short circuit.

According to one particular embodiment, the ribbon 30 may comprise 6 wires, as shown in FIG. 3. For example:
1 +12V
2 Mass
3 Invitation signal
4 Serial-mode data messages
5 Mass
6 +12V

The redundancy of the wires 1, 2 and 5, 6 makes it possible to address the reversibility constraint of the ribbon relative to the interfaces.

Thus, if the direction of the connector 32 is reversed relative to the interface 12, it is noted that the wire 1 will take the position of the wire 6, but these two wires correspond to the voltage +12 V. Likewise, the wire 2 will take the place of the wire 5, but these two wires correspond to the ground. Therefore, this reversal, by the human user, will not cause damage to the modules and the power distribution unit.

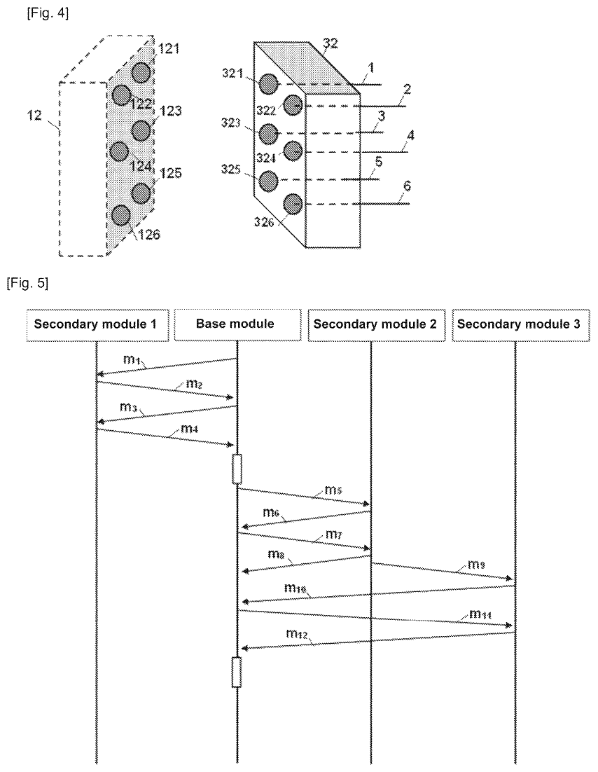

FIG. 4 shows other arrangements for an interface 12 of a module and for a connector 32 of the ribbon 30.

The interface 12 comprises 6 connection elements, 121, 122, 123, 124, 125, 126. The connector 32 of the ribbon also comprises 6 connection elements 321, 322, 323, 324, 325, 326, corresponding respectively to the wires 1, 2, 3, 4, 5, 6 of the ribbon. The connection elements 121 and 126 correspond to the supply voltage +12 V, and the elements 122 and 125 to the ground.

By connecting the connector to the interface, the wires 1, 2, 3, 4, 5, 6 are connected to the connection elements 121, 122, 123, 124, 125, 126 respectively.

By inverting the connector 32 (or the interface 12), the connection elements 121, 122, 123, 124, 125, 126 respectively become connected to the wires 6, 5, 4, 3, 2, 1. Therefore, the connection elements 121 and 126 remain connected to the voltage +12 V while the connection elements 122 and 125 remain connected to the ground. According to the invention, addresses are assigned to at least each socket of the set of secondary modules of the power distribution unit PDU. According to embodiments of the invention, addresses can also be assigned to other manageable objects, and to the input module. The manageable objects may be environmental sensors, for example (thermometers, hydrometry sensors, etc.).

The invention therefore provides a method for assigning addresses to electrical sockets of a power distribution unit.

This method may for example be implemented when powering up the power distribution unit. It may also be provided to trigger it again by sending a specific command to the basic unit (in order to reset the unit PDU following a problem for example, or new attachments).

FIG. 5 shows the progress of a method according to the invention on an example of a power distribution unit, PDU, composed of a base module and three secondary modules (secondary module 1, secondary module 2 and secondary module 3). The order of the modules shown corresponds to their physical arrangement in the unit PDU. Thus, the secondary module 1 is located on a first branch, connected to a first interface of the base module, and the secondary modules 2 and 3 are located on a second branch connected to a second interface of the base module.

In a first step, the base module transmits an invitation signal m₁ on a first interface, selected from the set of its interfaces. The choice may be any one.

When the processing of a first interface (through which secondary modules of a first branch are accessible), the base module will be able to process a second interface (through which secondary modules of a second branch are accessible), and so on in the case where more than two interfaces would be available.

As mentioned above, invitation signal m₁ can be a simple electrical signal on one wire of the ribbon 30, for example setting to a low voltage.

The management means of the secondary modules are adapted to continuously monitor the occurrence of this invitation signal, for example by continuously monitoring the level of this wire of the ribbon 30.

Detecting an invitation signal by a secondary module triggers the transmission of an address request message m₂ for each of the electrical sockets that it comprises.

The means for managing a secondary module can determine the number of electrical sockets that it comprises in different ways. For example, resistors placed on the printed circuit that can constitute the management means can make it possible to indicate the type of secondary module and, in particular, the number of sockets that it has available. Also, as indicated above, other manageable objects of the secondary module may require an address.

In general, in response to the invitation signal, a secondary module requires an address per manageable object that it has, including the electrical sockets. Thus, each manageable object will be addressable individually as soon as its address is known. The address request message m₂ therefore comprises an indication of the number of addresses required, in order to request an address for each manageable object.

This message m₂ is a data message transmitted by the data wire(s) of the ribbon 30. Different embodiments are possible for formatting this message. According to a particular embodiment, this message may be of the form:

TABLE 1

| | | | | |
|---|---|---|---|---|
| FC | Dest. | PL1 | PL2 | CRC |

The field FC (for “Function Code”) indicates a code of the function conveyed by the message. Its value may be a pre-set value to indicate that this is an address request. The “Dest” field may indicate the address of a destination manageable object. Here, it is the base module. This field may not play a role in the context of address assignment but may be important for managing the manageable objects, once the addresses have been assigned.

These first two fields form the header of the message.

The field “PL1” (for “Pay Load”) constitutes a first part of the payload of the message and can contain an indicator of a type of secondary module, in particular if it is a socket module, an input module or other types optionally yet to be defined.

The field “PL2” constitutes a second part of the payload of the message and can contain an indicator of the number of addresses required. This number can be encoded on 8 bits for example, making it possible to indicate up to 256 manageable objects. Typically, however, the number of sockets of a secondary module can be 2, 3, 8, etc.

The field “CRC” (for “Cyclic Redundancy Code”) is an error correction code, making it possible to verify that the message was properly transmitted.

In response to such an address request message m₂, the base module allocates as many unique addresses as indicated in the received request message.

These addresses can be determined by the base module as a function of the interface on which the address request message has been received, and of a reception rank of the message, when several messages are received.

Once assigned, an address can be stored within a data structure of the base module. Thus, the base module may have a set of addresses and assign them in order.

According to one embodiment, these available addresses can be a simple counter, which makes it possible to assign addresses in order and continuously, that is to say that a continuum of addresses is assigned, at the end of the allocation process, from the address 1 to the address N, where N is the total number of manageable objects within the power distribution unit, PDU.

For example, when it receives a first address request message, the base module allocates the first addresses of the available addresses (for example addresses 1, 2, 3, if 3 addresses are being requested). Then, when another address request message is received, another secondary module, other available addresses are assigned (for example addresses 4, 5, if two addresses are being requested), and so on.

Thus, for a given branch (corresponding to an interface of the base module), the addresses are assigned in the order of the chain consisting of the secondary modules, the first addresses being assigned to the manageable objects of the secondary module neighboring the base module.

Once a processed address request message and the assigned corresponding addresses are sent, they are transmitted by one or more address assignment messages m₃. According to one embodiment, a single address assignment message contains all of the addresses.

According to the embodiment where the addresses are counters assigned continuously and in order, it may be sufficient to transmit a boundary of the set of assigned addresses.

For example, if it is assumed that the secondary module 1 requires 8 addresses, the address assignment message may contain the value 8. This value may mean that the addresses 1 to 8 are assigned to it. In general, a secondary module requesting x addresses and receiving a value V can interpret this value as indicating that the addresses from V-x+1 to V are assigned to it as addresses.

A convention can be established in order to determine which socket of a secondary module matches an assigned address.

According to one embodiment, the addresses are assigned to the sockets of a secondary module as a function of an order in the physical arrangement of these sockets. In particular, an order corresponding to a physical distance rank of the base module can be employed.

For example, the first assigned address is assigned to the socket closest to the base module (that is, the interface on which the address assignment message was received), the second address is assigned to the immediately neighboring socket, and so on up to the last assigned address assigned to the socket furthest from the base module.

The format of the address assignment message m₃ must be of the same type as that of the address request message m₂.

In particular, this message m₃ is a data message transmitted by the data wire(s) of the ribbon 30. Different embodiments are possible for formatting this message. According to a particular embodiment, this message may be of the form:

TABLE 2

| | | | | |
|---|---|---|---|---|
| FC | Dest. | PL1 | PL2 | CRC |

The field FC (for “Function Code”) indicates a code of the function conveyed by the message. Its value may be a pre-set value to indicate that this is an address request. Indeed, the same value can be used in order to indicate that this address assignment message is a response (according to the protocol) to the address request message. The “Dest” field may indicate the address of a destination manageable object. Here, it is the base module. This field may not play a role in the context of address assignment but may be important for managing the manageable objects, once the addresses have been assigned.

These first two fields form the header of the message.

The field “PL1” (for “Pay Load”) constitutes a first part of the payload of the message and may contain, for example, an identifier of the power distribution unit. This field is optional.

The field “PL2” constitutes a second part of the payload of the message and can contain a boundary value of the address counter. This number can be encoded on 8 bits for example, making it possible to indicate up to 256 manageable objects.

The field “CRC” (for “Cyclic Redundancy Code”) is an error correction code, making it possible to verify that the message was properly transmitted.

In response to this address assignment message(s), the secondary module stores the addresses in an internal data structure within the management means.

It can transmit a confirmation message (or “acknowledgement message”), m₄ to indicate that it has successfully received the addresses corresponding to its request. The secondary module (that is, its management means) can further trigger the transmission of an invitation signal on another interface, that is to say to a neighboring module different from the one whose invitation signal it has itself received.

In the example of FIG. 5, the secondary module 1 does not have other neighbors than the base module and therefore cannot transmit this invitation signal.

Receiving a confirmation message m₄ by the base module can trigger a time counter. When a predetermined duration has elapsed after the reception of a last message on a given interface (therefore a confirmation message), it can be assumed that the whole of the branch corresponding to this interface has been processed.

The base module can then consider another interface and another branch. It then transmits an invitation signal m₅ on this other interface. The secondary modules all having the same behavior, the same address assignment process will therefore be implemented for this other branch. When all the interfaces have thus been processed (there are generally only two), the process of assigning addresses can be stopped, since all the sockets and other manageable objects have been assigned a unique address.

In the example of FIG. 5, the secondary module 1 being at the end of the branch, the base module only receives a single confirmation message m₄ on this interface. After the predetermined time has elapsed, it therefore transmits an invitation signal m₅ on its second interface.

This invitation signal is detected by the secondary module 2, which is its neighbor on the branch corresponding to this second interface.

In response, the secondary module 2 transmits an address request message me containing a number of addresses requested. In the example, it is assumed that the secondary module 2 has 3 electrical sockets. It therefore requires 3 unique addresses. In response to this message m₆, the base module determines new addresses, stores them, and transmits them in an address assignment message m₇.

For example, this message m₇ may contain the value 11, meaning that the addresses 9 to 11 are assigned thereto (that is to say V−x+1=9 to V=11, where x=3).

The secondary module stores these addresses, transmits a confirmation message m₈ on the interface by which it has received the assignment message, then transmits an invitation signal me on another interface (different from the one on which it has itself received an invitation signal)

This invitation signal me is detected by the next secondary module on the chain (i.e. the secondary module 3).

In response, the latter transmits a request message in addresses m₁₀ containing the number of addresses that it is requesting (corresponding to the number of manageable objects that it has). In this example, it is assumed that it comprises two electrical sockets and that it therefore is requesting two unique addresses. This message is transmitted on the same interface as that on which the invitation message was received.

The address request message m₁₀ is received by the secondary module 2.

That module determines that it does not concern it. Indeed, the secondary module 2 having already received an address assignment message previously, it no is longer waiting to receive one and therefore assumes that any new message of this type relates to another secondary module.

It then retransmits this message m₁₀ on its other interface.

Once received by the base module, that module then determines a number of unique addresses that corresponds to the value indicated by the address request message, which in this example is 2.

These addresses can be the next addresses in the ordered set of available addresses. It stores them and transmits them in an address assignment message m₁₁.

For example, this message m₁₁ may contain the value 13, meaning that the addresses 12 to 13 are assigned thereto (that is to say from V−x+1=11 to V=13, where x=2). This message m₁₁ passes from secondary module to secondary module, just like the previous message m₁₀. It finally arrives at the destination secondary module 3.

Indeed, the secondary modules having already received a secondary assignment message are in a state where they only transmit the new messages of this type, as seen previously.

The secondary module 3 stores these addresses, transmits a confirmation message m₁₂ on the interface by which it has received the assignment message, then checks whether it has a neighboring module on another interface (different from the one on which it has itself received an invitation signal) Since it does not, it cannot transmit invitation signals.

After receiving the confirmation message m₁₂, the base module no longer receives other messages. After a predetermined period of time, it may consider that the corresponding branch has been totally addressed. It can then consider a new interface, if there is another, or else (as is the case in the example illustrated by FIG. 5) interrupt the process of assigning addresses.

At this stage, the base module has stored the entire addressing space:
addresses 1 to 8: secondary module 1 on the first interface
addresses 9 to 11: secondary module 2 on the second interface
addresses 12 to 13: secondary module 3 on the second interface

If the example of the power distribution unit of FIG. 1 is taken up, in which the circles represent managed electrical sockets, and assuming that the base module 20 starts the addressing process on its left interface, the following addressing space is obtained:
Addresses 1, 2: module 10₄ on the left interface
Addresses 3, 4: modules 10₃ on the left interface
Address 5: module 10₂ on the left interface
Address 6: module 10₁ on the left interface
Addresses 7, 8: module 10₅ on the right interface,
Addresses 9, 10: module 10₆ on the right interface
Addresses 11, 12: module 10₇ on the right interface
Address 13: input module 10₈ on the right interface

Therefore, the method makes it possible to automate the assignment of unique addresses to the set of electrical sockets (or other managed elements) of a power distribution unit, without requiring a prior configuration.

Indeed, it is sufficient to connect a module to another module by means of a management ribbon, so that automatically the transmission of the invitation signals and of the address request messages, address assignment, and confirmation makes it possible to assign the correct number of addresses to this module.

Whatever the number of sockets and modules, it is thus possible to address them property. According to one embodiment, the mechanism for assigning an address based on a counter makes it possible to further ensure the uniqueness of the addresses and is simple to implement. However, other embodiments can be envisaged.

The use of the invitation signal makes it possible to sequence the address assignments module by module, in a structured and known order. Thus, all the addresses assigned to the same module are necessarily contiguous. Likewise, two neighboring modules necessarily have neighboring addresses. This mechanism therefore greatly facilitates the management of module addressing tables and message routing mechanisms for managing the unit PDU.

According to one embodiment, the base module comprises a management interface enabling exchanges with external devices, by means of management messages. These management messages may comprise at least one socket address (or address of another manageable object), as previously assigned.

Thus, the addresses assigned by the invention can allow management devices to individually manage each of the plugs of the power distribution unit.

It may in particular be possible to receive messages containing measurements or other information from the sockets, and whose address makes it possible to identify them. In the other direction, an external device can control the remote measurements, by means of their unique addresses, to turn them on, off, etc.

The management messages can conform to the various standards for remote management of network or electronic equipment. One example of such a standard is SNMP protocol (“Simple Network Management Protocol”). Other mechanisms are possible as an interface of the CLI type (“Command Line Interface”), or the implementation of a Web server within the base module that can be accessible by external devices via the protocol http.

According to one embodiment, several power distribution units can be connected to each other. A first unit is connected to a second, itself connected to a third and so on, in “cascade” fashion. Only the unit at the start of the chain may have a management interface, which can thus allow the interfacing of all the units interconnected with external devices.

In such a situation, it may be desirable for the electrical sockets of all the power distribution units to constitute only a single addressing space for external devices.

Thus, an address can be determined by combining a locally unique address to a power distribution unit (for example a counter), and an identifier of the power distribution unit. This way of constructing the addresses makes it possible to address all the sockets of a set of several PDUs, in a unique way.

Of course, the present invention is not limited to the examples and embodiment described and shown, but is defined by the claims. In particular, it is susceptible to numerous variants accessible to the skilled artisan.

1. A secondary module for a power distribution unit (PDU), comprising
a set of electrical sockets connected to an internal connection socket enabling an energy supply by an input module of said power distribution unit
at least one interface for transmitting data with another module in said power distribution unit,
management means for individually managing the electrical sockets of said set, by means of messages exchanged, via said at least one interface, with a base module of said power distribution unit, identifiers of an electrical socket of said set that is determined by a unique address,
wherein said management means are adapted to, in response to an invitation signal received on a first interface among said at least one interface, transmit, on said first interface, an address request message specifying the number of electrical sockets of said set, and, to store said one or more addresses, in response to one or more address assignment messages.

2. The secondary module according to claim 1, wherein said management means are adapted to, after having received said one or more assignment messages, transmit a second invitation signal on a second interface among said at least one interface, said second interface being distinct from said first interface.

3. A base module for a power distribution unit, comprising
at least one interface for transmitting data with a secondary module in said power distribution unit,
management means adapted to issue an invitation signal on a first interface among said at least one interface, then to, in response to an address request message received on said first interface, assign one or more unique addresses and to transmit same over said first interface, in the form of one or more address assignment messages.

4. The base module according to the claim 3, wherein said management means are adapted to emit a new invitation signal on a second interface from said at least one interface, when a predetermined duration has elapsed after the reception of a last message via said first interface.

5. The base module according to claim 3, comprising a management interface enabling exchanges of management messages with external devices, comprising at least one socket address.

6. The secondary module according to claim 1, wherein the management means are composed of a printed circuit comprising a programmable microcontroller, a memory and circuits enabling the connection between said microcontroller, said memory and said at least one interface.

7. The secondary module according to claim 1, wherein said at least one interface comprises a unidirectional wire connector for the transmission of said invitation signal, and a connector for a set of bidirectional wires for the transmission of said messages.

8. The secondary module according to claim 1, wherein said invitation signal corresponds to a predetermined level of voltage on said unidirectional wire.

9. The secondary module according to claim 1, wherein said unique addresses are assigned by a counter of said base module, said address assignment messages contain a value of said counter, and said secondary module determines the unique addresses assigned to the sockets of said set depending on said value and said number of sockets, in a predetermined order.

10. The power distribution unit comprising a base module according to claim 3, said module being connected via their at least one respective interface, so as to form a chain.

11. The power distribution unit according to the claim 10, further comprising an input module comprising a electrical supply socket.

12. The power distribution unit according to claim 10, wherein, said at least one interface further comprises two pairs of connectors for the power supply of said management means, the two pairs being arranged so that said interface is reversible, and the supply being provided by a current converter arranged in said base module.

13. A method for assigning addresses to electrical sockets of a power distribution unit, comprising a base module comprising at least one interface through which at least one secondary module is accessible comprising a set of electrical sockets connected to an internal connection socket enabling an energy supply by an input module of said power distribution unit,
wherein, for each of said at least one interface, said base module transmits an invitation signal,
then, iteratively:
said at least one secondary module transmits, upon receipt of said invitation signal, an address request message to said base module, indicating the number of electrical sockets of said assembly;
said base module assigns a unique address for each socket, and transmits such address(es) as one or more address assignment messages;
said at least one secondary module stores the unique address(es), then transmits a second invitation signal to another secondary module among said at least one secondary module, if there is one.

14. A data processing center comprising at least one power distribution unit according to claim 12.

15. The data processing center according to the claim 14, further comprising an external management device adapted to exchange with said power distribution unit by means of management messages comprising at least one socket address.
